(19) United States
(12) Patent Application Publication
(10) Pub. No.: US 2015/0207141 A1
(43) Pub. Date: Jul. 23, 2015

(54) NEGATIVE ELECTRODE FOR NONAQUEOUS ELECTROLYTE SECONDARY BATTERY, METHOD FOR MANUFACTURING THE SAME, AND NONAQUEOUS ELECTROLYTE SECONDARY BATTERY

(71) Applicant: SANYO ELECTRIC CO., LTD., Moriguchi-shi, Osaka (JP)

(72) Inventors: Shun Nomura, Tokushima (JP); Taisuke Yamamoto, Osaka (JP); Hidekazu Yamamoto, Osaka (JP); Atsushi Kaiduka, Tokushima (JP); Naoki Imachi, Hyogo (JP)

(73) Assignee: SANYO ELECTRIC CO., LTD., Moriguchi-shi, Osaka (JP)

(21) Appl. No.: 14/413,259

(22) PCT Filed: Aug. 26, 2013
(86) PCT No.: PCT/JP2013/005013

§ 371 Date: Jan. 7, 2015

(30) Foreign Application Priority Data
Aug. 31, 2012 (JP) 2012-191239

(51) Int. Cl. H01M 4/36; H01M 4/48; H01M 4/583; H01M 4/60

(52) U.S. Cl. CPC H01M 4/366; H01M 4/60; H01M 4/48; H01M 4/583; H01M 2220/30

(57) ABSTRACT

The present invention provides a nonaqueous electrolyte secondary battery which can significantly improve battery characteristics by suppression of decrease in discharge capacity at an initial cycle stage and by improvement in high-temperature charge storage characteristics. A negative electrode for a nonaqueous electrolyte secondary battery has a negative electrode mixture layer including a negative electrode active material which contains SiOₓ (0.8≦x≦1.2) and graphite; and a negative electrode collector having at least one surface on which the negative electrode mixture layer is formed, and on the surface of the SiOₓ, a coating film derived from a compound having an isocyanate group is formed.

### TECHNICAL FIELD

The present invention relates to a negative electrode for a nonaqueous electrolyte secondary battery, a method for manufacturing the same, and a nonaqueous electrolyte secondary battery.

### BACKGROUND ART

In recent years, reduction in size and weight of mobile information terminals, such as a mobile phone, a notebook personal computer, and a smart phone, has been rapidly advanced, and a battery functioning as a drive power source thereof has been required to have a higher capacity. In concomitant with charge and discharge, since a nonaqueous electrolyte secondary battery which performs charge and discharge by the movement of lithium ions between a positive electrode and a negative electrode has a high energy density and a high capacity, this secondary battery has been widely used as a drive power source of the mobile information terminals as described above.

The mobile information terminals described above tend to consume a larger amount of electric power in association with enhancement of functions, such as a video reproduction function and a game function, and for example, in order to achieve a long-time reproduction and an output improvement, the nonaqueous electrolyte secondary battery functioning as a drive power source of the mobile information terminals is strongly required to have a higher capacity and to improve charge and discharge performance.

In the nonaqueous electrolyte secondary battery described above, in general, lithium cobaltate and graphite are used as a positive electrode active material and a negative electrode active material, respectively; however, by the use of those materials, it is difficult to further increase the capacity. Hence, development of an active material having a higher specific capacity has been carried out. For example, as for the negative electrode active material, material development of a silicon alloy and the like has been actively pursued. When this material is used, although the specific capacity can be significantly increased as compared to that in the case of graphite, the volume expansion is large, and a problem in terms of safety still remains to be solved. Hence, nowadays, development of an oxide negative electrode having a smaller volume expansion and a high safety has been preferentially carried out.

For example, a proposal has been made in which by the use of a negative electrode active material prepared by mixing graphite and a silicon oxide having a high specific capacity and a smaller volume expansion rate than that of a silicon alloy, the capacity of a battery is increased (Patent Literature 1).

In addition, a proposal has been made in which a compound having an isocyanate group is added to an electrolyte to generate a preferable SEI on a negative electrode, and by this SEI, improvement in cycle characteristics and/or suppression of swelling during high-temperature storage is performed (Patent Literature 2 and 3).

### CITATION LIST

### Patent Literature

PTL 1: Japanese Published Unexamined Patent Application No. 2011-233245
PTL 2: Japanese Published Unexamined Patent Application No. 2006-164759
PTL 3: Japanese Published Unexamined Patent Application No. 2007-242411

### SUMMARY OF INVENTION

### Technical Problem

However, by the negative electrode formed by mixing a silicon oxide and graphite as is the proposal disclosed in the above Patent Literature 1, the capacity is remarkably decreased at an initial cycle stage. Hence, there has been a problem in that the advantage of increase in capacity of the battery disappears at the initial cycle stage. Through research on this problem carried out by the inventors of the present invention, it was found that since the reactivity of the silicon oxide with an electrolyte is higher than that of graphite, the SEI on the silicon oxide is increased, and as a result, the electron conductivity is lost. As a result, since a silicon oxide containing lithium is isolated in the negative electrode, the problem described above occurs. In addition, since the reactivity of the silicon oxide with an electrolyte is high, during high-temperature charge storage, battery swelling caused by gas generation disadvantageously occurs.

In addition, in the proposals disclosed in the above Patent Literature 2 and 3, although the case in which graphite is only used as the negative electrode active material is described, a negative electrode formed by mixing a silicon oxide and graphite has not been discussed.

### Solution to Problem

A nonaqueous electrolyte secondary battery of the present invention comprises: a negative electrode mixture layer including a negative electrode active material which contains SiOₓ (0.8≦x≦1.2) and graphite; and a negative electrode collector having at least one surface on which the negative electrode mixture layer is formed, and on the surface of the SiOₓ, a coating film derived from a compound having an isocyanate group is formed.

### Advantageous Effects of Invention

According to the present invention, excellent effects, such as suppression of the decrease in discharge capacity at an initial cycle stage and improvement in high-temperature charge storage characteristics, can be obtained.

### DESCRIPTION OF EMBODIMENTS

Hereinafter, a nonaqueous electrolyte secondary battery and the like of the present invention will be described. Incidentally, the nonaqueous electrolyte secondary battery and the like of the present invention are not limited to those shown in the following embodiments and may be appropriately changed and/or modified within the scope of the present invention.

<Formation of Positive Electrode>

After acetylene black functioning as a conductive agent, a poly(vinylidene fluoride) (PVdF) functioning as a binder, and N-methyl-2-pyrrolidone (NMP) functioning as a dispersant are added to lithium cobaltate functioning as a positive electrode active material so that the mass ratio of the positive electrode active material, the conductive agent, and the binder is 95.0:2.5:2.5, kneading is performed, so that a positive electrode slurry is prepared. Subsequently, after this positive electrode slurry is applied to two surfaces of a positive electrode collector formed of aluminum foil and then dried, rolling is performed using rolling rollers, and a positive electrode collector tab is fitted, so that a positive electrode is formed. In addition, the bulk density of the positive electrode is set to 3.60 g/cm³.

<Surface Treatment of SiOₓ>

After 200 g of a diethyl carbonate (DEC) solution in which 1 percent by mass of hexamethylene diisocyanate (HMDI) is dissolved is prepared, 44 g of SiOₓ (x=0.93, average particle diameter: 5.0 μm) is added to the above solution and then stirred at room temperature for 10 minutes, and subsequently, suction filtration is performed. Next, after the SiOₓ is washed with DEC, the powder thus obtained is vacuum-dried, so that a SiOₓ (SiOₓ having a chemically modified surface), the surface of which is cover with a coating film (coating film derived from a compound having an isocyanate group) that suppresses a reduction reaction of a nonaqueous electrolyte, is obtained. In addition, by the use of a gas chromatography, it is confirmed that all the HMDI is consumed for the reaction. In addition, the rate of the coating film with respect to the SiOₓ is 1 percent by mole.

<Formation of Negative Electrode>

After artificial graphite functioning as a negative electrode active material and an SBR (styrene-butadiene rubber) functioning as a binder are added to an aqueous solution in which the SiOₓ functioning as a negative electrode active material and a CMC (sodium carboxymethyl cellulose) functioning as a thickener are dissolved, kneading is performed, so that a negative electrode slurry is prepared. In this step, the mass ratio of the negative electrode active material (total of the artificial graphite and the SiOₓ), the binder, and the thickener is set to 98:1:1, and the mass ratio of the artificial graphite to the SiOₓ is set to 95:5. Subsequently, after this negative electrode slurry is applied to two surfaces of a negative electrode collector formed of copper foil and then dried, rolling is performed using rolling rollers to obtain a bulk density of 1.60 g/cm³, and a negative electrode collector tab is fitted, so that a negative electrode is formed.

<Preparation of Nonaqueous Electrolyte>

Hexafluoro lithium phosphate (LiPF₆) is dissolved in a mixed solvent of ethylene carbonate (EC) and diethylene carbonate (DEC) at a volume ratio of 3:7 so that the concentration is 1.0 mole/liter, and 1.0 percent by mass of vinylene carbonate (VC) is also added, so that a nonaqueous electrolyte is prepared.

<Formation of Battery>

The positive electrode and the negative electrode are wound to face each other with at least one separator formed of a polyethylene porous film having a thickness of 22 μm interposed therebetween, so that a wound body is formed. Next, the wound body is sealed in an aluminum laminate together with the above nonaqueous electrolyte in a glow box in an argon atmosphere, so that a nonaqueous electrolyte secondary battery (3.6 mm in thickness, 3.5 cm in width, and 6.2 cm in length) is formed. The discharge capacity of this nonaqueous electrolyte secondary battery obtained by charge to 4.40 V and subsequent discharge to 2.75 V is 800 mAh.

### EXAMPLES

### Example 1

A battery was formed in a manner similar to that of the embodiment of the present invention.

The battery thus formed was called a battery A1.

### Example 2

Except that in the surface treatment of SiOₓ, the rate of HMDI dissolved in DEC was set to 5 percent by mass, a battery was formed in a manner similar to that of the above Example 1. In addition, by the use of a gas chromatography, it was confirmed that all the above HMDI was consumed for the reaction. The same confirmation as described above was also obtained in the following Examples 3 to 6. In addition, the rate of the coating film to the SiOₓ was 6 percent by mole.

The battery thus formed was called a battery A2.

### Example 3

Except that in the surface treatment of SiOₓ, the rate of HMDI dissolved in DEC was set to 10 percent by mass, a battery was formed in a manner similar to that of the above Example 1. In addition, the rate of the coating film to the SiOₓ was 12 percent by mole.

The battery thus formed was called a battery A3.

### Example 4

Except that in the surface treatment of SiOₓ, the rate of HMDI dissolved in DEC was set to 15 percent by mass, a battery was formed in a manner similar to that of the above Example 1. In addition, the rate of the coating film to the SiOₓ was 18 percent by mole.

The battery thus formed was called a battery A4.

### Example 5

Except that in the surface treatment of SiOₓ, the rate of HMDI dissolved in DEC was set to 20 percent by mass, a battery was formed in a manner similar to that of the above Example 1. In addition, the rate of the coating film to the SiOₓ was 24 percent by mole.

The battery thus formed was called a battery A5.

### Example 6

Except that in the surface treatment of SiOₓ, hexyl isocyanate was used instead of using HMDI, a battery was formed in a manner similar to that of the above Example 3. In addition, the rate of the coating film to the SiOₓ was 18 percent by mole.

The battery thus formed was called a battery A6.

### Comparative Example 1

Except that the surface treatment of SiOₓ was not performed, a battery was formed in a manner similar to that of the above Example 1.

The battery thus formed was called a battery Z1.

### Comparative Example 2

Except that the surface treatment of SiOₓ was not performed, and that 1.0 percent by mass of HMDI was added to a nonaqueous electrolyte, a battery was formed in a manner similar to that of the above Example 1.

The battery thus formed was called a battery Z2.

### Comparative Example 3

Except that in the surface treatment of SiOₓ, HMDI was not dissolved in DEC, a battery was formed in a manner similar to that of the above Example 1.

The battery thus formed was called a battery Z3.

(Experiment) Charge, discharge, and the like of each of the batteries A1 to A6 and Z1 to Z3 were performed under the following conditions to evaluate cycle characteristics (capacity retention rate after 50 cycles, characteristics at an initial cycle stage) and high-temperature continuous charge characteristics (battery swelling amount caused by gas generation, capacity remaining rate), and the results thereof are shown in Table 1.

[Cycle Characteristic Test]

After constant current charge was performed until the battery voltage reached 4.4 V at a current of 1.0 It (800 mA), discharge was performed at a constant voltage of 4.4 V until the current reached 40 mA. After a rest for 10 minutes, a constant current discharge was performed at a current of 1.0 It (800 mA) until the battery voltage reached 2.75 V. This test was performed at room temperature (25° C.).

Capacity retention rate (%) after 50 cycles=[discharge capacity at 50-th cycle/discharge capacity at first cycle]×100 (1)

[High-Temperature Charge Storage Test]

After charge was performed to 4.4 V at room temperature under the conditions similar to the charge conditions shown in the above cycle characteristic test, the battery was left for 48 hours in a constant-temperature bath at 80° C. Subsequently, after the battery was recovered from the constant-temperature bath and cooled to room temperature, the battery thickness was measured, and from the following formula (2), the battery swelling amount was calculated. Furthermore, after discharge was performed to 2.75 V under the conditions similar to the discharge conditions shown in the above cycle characteristic test, the discharge capacity was measured, and the capacity remaining rate was obtained from the following formula (3).

Battery swelling amount (mm)=battery thickness after charge and storage−battery thickness before charge and storage (2)

Capacity remaining rate (%)=[discharge capacity after charge and storage/discharge capacity before charge and storage]×100 (3)

TABLE 1

| | | | | | Cycle | High-Temperature | |
|---|---|---|---|---|---|---|---|
| | Coating Film Formed on SiOₓ Surface | | | | Characteristics | Charge Storage | |
| | Compound for Coating | | Rate of | | Capacity | Characteristics | |
| | Film Formation | | Coating Film | Additive to | Retention | Battery | Capacity |
| | | Concentration | to SiOₓ | Electrolyte | Rate after | Swelling | Remaining |
| | | (Percent | (Percent | (Addition | 50 Cycles | Amount | Rate |
| Battery | Type | by Mass) | by mole) | Amount) | (%) | (mm) | (%) |
| A1 | HMDI | 1 | 1 | None | 83 | +0.30 | 70 |
| A2 | | 5 | 6 | | 84 | +0.24 | 72 |
| A3 | | 10 | 12 | | 87 | +0.20 | 72 |
| A4 | | 15 | 18 | | 85 | +0.19 | 73 |
| A5 | | 20 | 24 | | 83 | +0.25 | 71 |
| A6 | Hexyl | 10 | 18 | | 83 | +0.29 | 71 |
| | Isocyanate | | | | | | |
| Z1 | — | No Treatment | 0 | | 82 | +0.35 | 69 |
| Z2 | — | No Treatment | — | HMDI | 77 | +0.33 | 70 |
| | | | | (1 Percent | | | |
| | | | | by Mass) | | | |
| Z3 | — | 0 | 0 | None | 82 | +0.34 | 69 |
| | | (Only DEC) | | | | | |

As shown in Table 1, it is found that compared to the batteries Z1 and Z3, the batteries A1 to A6 are superior in terms of cycle characteristics (high capacity retention rate after 50 cycles) and also in high-temperature charge storage characteristics (small battery swelling amount, and high capacity remaining rate). However, in batteries A6 and A4, it is found that although the rate of the coating film to the SiOₓ was the same (18 percent by mole for each battery), the battery A6 is slightly inferior to the battery A4 in terms of cycle characteristics and high-temperature charge storage characteristics. It is believed that the above test results are obtained by the following reasons.

In the batteries A1 to A6, since an isocyanate group of HMDI or hexyl isocyanate is allowed to react with an OH group on the SiOₓ surface before the negative electrode is formed, an urethane bond is formed. Accordingly, since a coating film (pseudo SEI) is formed on the SiOₓ surface, a reaction between the SiOₓ and the electrolyte is suppressed in charge and discharge. As a result, the isolation of the SiOₓ caused by the increase of the SEI can be suppressed, and hence, the cycle characteristics are improved. In addition, since the reaction between the nonaqueous electrolyte and the SiOₓ can be suppressed, the high-temperature charge storage characteristics are also improved. In contrast, in the batteries Z1 and Z3, since the coating film (pseudo SEI) is not formed on the SiOₓ surface, the reaction between the SiOₓ and the nonaqueous electrolyte cannot be suppressed. Hence, since the isolation of the SiOₓ caused by the increase of the SEI cannot be suppressed, the cycle characteristics are degraded. In addition, since the reaction between the SiOₓ and the electrolyte cannot be suppressed, the high-temperature charge storage characteristics are also degraded.

In addition, in the surface treatment of the SiOₓ, if a compound having at least two isocyanate groups is used, since a coating film having a cross-linked structure is formed on the SiOₓ surface as shown by the following Chem. 1, the reaction between the electrolyte and the SiOₓ can be sufficiently suppressed. In contrast, in the surface treatment of the SiOₓ, if a compound having only one isocyanate group is used, since the coating film formed on the SiOₓ surface has no cross-linked structure, the degree of suppression of the reaction between the electrolyte and the SiOₓ is slightly degraded. Hence, in terms of both the cycle characteristics and the high-temperature charge storage characteristics, the battery A4 processed by HMDI, which is a compound having at least two isocyanate groups, is superior to the battery A6 processed by a compound having only one isocyanate group.

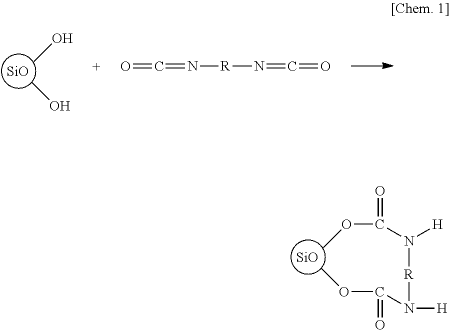

[R in Chem. 1 represents CₙH₂ₙ (n indicates an integer of 1 or more.)]

In addition, when the battery Z1 is compared to the battery Z3, it is found that the cycle characteristics and the high-temperature charge storage characteristics are approximately equivalent to each other. Hence, it is understood that the effect of the present invention is not obtained by the immersion of SiOₓ in an organic solvent but is obtained by a reaction between SiOₓ and HMDI or hexyl isocyanate.

Furthermore, it is found that the battery Z2 is inferior to the batteries Z1 and Z3 in terms of the cycle characteristics. The reason for this is believed that since HMDI is added to the nonaqueous electrolyte of the battery Z2, the coating film derived from HMDI is also formed on carbon, and hence, the degradation in capacity occurs.

In addition, when the batteries A1 to A5 are compared to each other, it is found that the batteries A2 to A4 are superior to the batteries A1 and A5 in terms of the cycle characteristics and the high-temperature charge storage characteristics. Hence, the rate of the coating film to the SiOₓ is preferably 6 to 18 percent by mole.

(Other Items)

(1) As the compound having at least two isocyanate groups, besides hexamethylene diisocyanate mentioned above, for example, there may be mentioned tetramethylene diisocyanate, pentamethylene diisocyanate, heptamethylene diisocyanate, octamethylene diisocyanate, nonamethylene diisocyanate, decamethylene diisocyanate, undecamethylene diisocyanate, dodecamethylene diisocyanate, 1,3-bis(isocyanatomethyl)cyclohexane, 1,4-bis(isocyanatomethyl)cyclohexane, 1,3-cyclopentane diisocyanate, 1,3-cyclohexane diisocyanate, and 1,4-cyclohexane diisocyanate.

(2) The content of the SiOₓ in the negative electrode mixture is preferably 0.5 to 25 percent by mass and particularly preferably 1.0 to 20 percent by mass. When the content of the SiOₓ is excessively small, the increase in negative electrode capacity may not be achieved in some cases. In contrast, when the content of the SiOₓ is excessively large, since the negative electrode expansion is increased, for example, peeling of the negative electrode mixture layer and/or the deformation of the negative electrode collector occurs, and the cycle characteristics may be degraded in some cases.

(3) As a lithium transition metal composite oxide used in the present invention, besides the above lithium cobaltate, for example, there may be used known oxides of lithium and a transition metal, such as nickel-cobalt-lithium manganate, nickel-cobalt-lithium aluminate, nickel-lithium cobaltate, nickel-lithium manganate, lithium nickelate, and lithium manganate; and known olivine acid compounds of iron and manganese.

(4) As the solvent of the nonaqueous electrolyte used in the present invention, solvents and additives which have been used heretofore for nonaqueous electrolyte secondary batteries may be simultaneously used. For example, there may be used cyclic carbonates, such as ethylene carbonate, propylene carbonate, butylene carbonate, and vinylene carbonate; chain carbonates, such as dimethyl carbonate, methyl ethyl carbonate, and diethyl carbonate; compounds having an ester, such as methyl acetate, ethyl acetate, propyl acetate, methyl propionate, ethyl propionate, and γ-butyrolactone; compounds having a sulfonic group, such as propanesultone; compounds having an ether, such as 1,2-dimethoxyethane, 1,2-diethoxyethane, tetrahydrofuran, 1,2-dioxane, 1,4-dioxane, and 2-methyl tetrahydrofuran; and compounds having a nitrile, such as butyronitrile, valeronitrile, n-heptanenitrile, succinonitrile, glutarnitrile, adiponitrile, pimelonitrile, 1,2,3-propanetricarbonitrile, 1,3 5-pentanetricarbonitrile; and compounds having an amide, such as dimethylformamide. In particular, among those mentioned above, a solvent in which at least one H is replaced by F is preferably used. In addition, those mentioned above may be used alone, or at least two thereof may be used in combination, and a solvent which contains at least one of those mentioned above and a compound having a nitrile and/or a compound having an ether in combination is preferable.

Furthermore, as a solute used in the above nonaqueous electrolyte, a known lithium slat which has been generally used in nonaqueous electrolyte secondary batteries may be used. As the lithium salts described above, a lithium salt containing at least one element selected from P, B, F, O, S, N, and Cl may be used, and in particular, a lithium salt, such as LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, LiAsF₆, and LiClO₄, and a mixture thereof may be used. In particular, in order to enhance highly efficient charge discharge characteristics and the durability of the nonaqueous electrolyte secondary battery, LiPF₆ is preferably used.

In addition, as the solute, a lithium salt containing an oxalate complex as an anion may also be used. As the lithium salt containing an oxalate complex as an anion, besides LiBOB (lithium bisoxalate borate), for example, there may be used a lithium salt containing an anion in which C₂O₄²⁻ is coordinated to a central atom, such as Li[M(C₂O₄)ₓR_{y}] (in the formula, M represents an element selected from transition metals and elements of Group IIIb, IVb, and Vb of the period table; R represents a group selected from a halogen, an alkyl group, and a halogenated alkyl group; x indicates a positive integer; and y indicates 0 or a positive integer). In particular, for example, Li[B(C₂O₄)F₂], Li[P(C₂O₄)F₄], and Li[P(C₂O₄)₂F₂] may be mentioned. However, in order to form a stable coating film on the surface of the negative electrode even in a high-temperature environment, LiBOB is most preferably used.

In addition, although the above solutes may be used alone, at least two types thereof may also be used together by mixing. In addition, although the concentration of the solute is not particularly limited, a concentration of 0.8 to 1.7 moles per one liter of the electrolyte is preferable. Furthermore, for application which requires a discharge at a large current, the concentration of the solute is preferably 1.0 to 1.6 moles per liter of the electrolyte.

(5) As the separator used in the present invention, a separator which has been used heretofore may be used. In particular, besides a separator formed from a polyethylene, a separator prepared by forming a layer of a polypropylene on the surface of a polyethylene layer, or a separator prepared by applying a resin, such as an aramid resin, on the surface of a polyethylene separator may also be used.

(6) At the interface between the positive electrode and the separator, or at the interface between the negative electrode and the separator, a layer formed from an inorganic filler which has been used heretofore may be formed. As the filler, an oxide or a phosphate compound, each of which uses at least one of titanium, aluminum, silicon, magnesium, and the like, may be used, or a filler having a surface processed by a hydroxide or the like may also be used.

For the formation of the above filler layer, for example, a method for directly applying a filler-containing slurry to the positive electrode, the negative electrode, or the separator or a method for adhering a sheet formed from a filler to the positive electrode, the negative electrode, or the separator may be used.

### INDUSTRIAL APPLICABILITY

The present invention is expected to be applied, for example, to a drive power source of a mobile information terminal, such as a mobile phone, a notebook personal computer, or a smart phone; a high-output drive power source of an electric car, a HEV, or an electric tool; and a storage-related power source.

1-6. (canceled)

7. A negative electrode for a nonaqueous electrolyte secondary battery, comprising:
a negative electrode mixture layer including a negative electrode active material which contains SiOₓ (0.8≦x≦1.2) and graphite; and
a negative electrode collector having at least one surface on which the negative electrode mixture layer is formed,
wherein on the surface of the SiOₓ, a coating film derived from a compound having an isocyanate group is formed.

8. The negative electrode for a nonaqueous electrolyte secondary battery according to claim 7,
wherein the coating film derived from a compound having an isocyanate group is formed only on the SiOₓ of the negative electrode active material.

9. The negative electrode for a nonaqueous electrolyte secondary battery according to claim 7,
wherein the compound having an isocyanate group includes at least two isocyanate groups.

10. The negative electrode for a nonaqueous electrolyte secondary battery according to claim 8,
wherein the compound having an isocyanate group includes at least two isocyanate groups.

11. The negative electrode for a nonaqueous electrolyte secondary battery according to claim 7,
wherein the rate of the coating film to the SiOₓ is 6 to 18 percent by mole.

12. The negative electrode for a nonaqueous electrolyte secondary battery according to-claim 8,
wherein the rate of the coating film to the SiOₓ is 6 to 18 percent by mole.

13. A nonaqueous electrolyte secondary battery comprising:
the negative electrode according to claim 7;
a positive electrode including a positive electrode collector and a positive electrode mixture layer formed on at least one surface thereof;
a separator disposed between the positive electrode and the negative electrode; and
a nonaqueous electrolyte.

14. A nonaqueous electrolyte secondary battery comprising:
the negative electrode according to claim 8;
a positive electrode including a positive electrode collector and a positive electrode mixture layer formed on at least one surface thereof;
a separator disposed between the positive electrode and the negative electrode; and
a nonaqueous electrolyte.

15. A negative electrode for a nonaqueous electrolyte secondary battery, comprising:
a negative electrode mixture layer including a SiOₓ (0.8≦x≦1.2) particle as a negative electrode active material and graphite as a negative electrode active material; and
a negative electrode collector having at least one surface on which the negative electrode mixture layer is formed,
wherein on the surface of the SiOₓ, a coating film derived from a compound having an isocyanate group is formed.

16. The negative electrode for a nonaqueous electrolyte secondary battery according to claim 15,
wherein the coating film derived from a compound having an isocyanate group is formed only on the SiOₓ particle of the negative electrode active material.
